(19) United States
(12) Patent Application Publication
(10) Pub. No.: US 2007/0289177 A1
(43) Pub. Date: Dec. 20, 2007

(54) Decorative cyclone globe

(76) Inventor: Sheng-Hung Hsu, Renwu Hsiang (TW)

Correspondence Address: HERSHKOVITZ & ASSOCIATES, 2845 DUKE STREET, ALEXANDRIA, VA, 22314, US

(21) Appl. No.: 11/442,325

(22) Filed: May 30, 2006

(51) Int. Cl. G09F 19/00

(52) U.S. Cl. 40/409

(57) ABSTRACT

A decorative cyclone globe has a driving assembly, a spherical shell, a central decoration and multiple flying objects. The driving assembly has a pedestal, a motor and a blower. The pedestal has a base, a base bracket mounted on the base, a mounting ring mounted on the base bracket and a mounting dish mounted on the mounting ring. The motor is mounted in the mounting dish. The blower is mounted on and driven by the motor. The spherical shell is transparent and has an open bottom mounted on the mounting ring. The central decoration is mounted on the mounting dish in the spherical shell. The flying objects are in the spherical shell are blown around inside the spherical shell when the blower generates a swirling wind inside the spherical shell to show a dynamic effect.

### BACKGROUND OF THE INVENTION

1. Field of the Invention

The present invention relates to a decorative globe, and more particularly to a decorative cyclone globe that creates a swirling wind within the decorative cyclone globe.

2. Description of Related Art

For advertisement or theme awareness, conventional inflatable decorative devices are used in exhibitions. The inflatable decorative devices are made of cloth sewn together and has to be connected to an air blower so that the inflatable decorative injecting devices can be inflated to form a particular figure (animals, special icons, cartoon characters, etc.) and to be erected to attract people's attention.

However, the conventional inflatable decorative device is static and cannot depict a theme scene without being arranged with other inflatable decorative devices. Further, the inflatable decorative devices are exhibited in an open environment, so special effects, such as a blizzard, cannot be realistically depicted.

The present invention has arisen to mitigate or obviate the disadvantages of the conventional inflatable decorative device.

### SUMMARY OF THE INVENTION

The primary objective of the present invention is to provide a decorative cyclone globe that forms a closed environment in which a dynamic swirling wind is generated to enhance the display.

The decorative cyclone globe comprises a driving assembly, a spherical shell, a central decoration and multiple flying objects.

The driving assembly has a pedestal, a motor and a blower. The pedestal comprises a base, a base bracket, a mounting ring, a mounting dish and a motor bracket cap. The base has a top surface. The base bracket is mounted on the base and has a tubular wall with a bottom edge and a top edge. The mounting ring is mounted on the top edge of the tubular wall. The mounting dish is mounted on the mounting ring and has a bottom surface and a motor bracket. The motor bracket is formed on and protrudes from the bottom surface of the mounting dish, extends downward through the mounting ring and has a through hole defined through the mounting dish. The motor bracket cap is mounted on the motor bracket under the mounting dish and has a bottom. The motor is mounted in the motor bracket cap against the bottom of the position bracket and has a shaft. The blower is attached to and rotates with the motor shaft and has multiple blades. The blades rotate and create a swirling wind when the motor shaft rotates the blower.

The spherical shell is transparent, is attached to the mounting ring of the driving assembly, forms a visible closed environment inside the spherical shell and has an open bottom attached to the mounting ring.

The central decoration is mounted on the mounting dish inside the spherical shell and may be a cartoon character or a model of a village, a hill, etc. to show a theme scene.

The multiple flying objects are in the spherical shell, lie on the mounting dish in a default situation and fly with the swirling wind to present a dynamic effect, e.g. a blizzard, a hurricane or a tornado when the blades of the blower rotate.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a decorative cyclone globe in accordance with the present invention;

FIG. 2 is an operational front view in partial section of the decorative cyclone globe in FIG. 1;

FIG. 3 is an enlarged front view in partial section of the decorative cyclone globe in FIG. 1; and

FIG. 4 is an operational cross sectional top view of the decorative cyclone globe along line 4-4 in FIG. 2.

### DETAILED DESCRIPTION OF THE PREFERRED EMBODIMENT

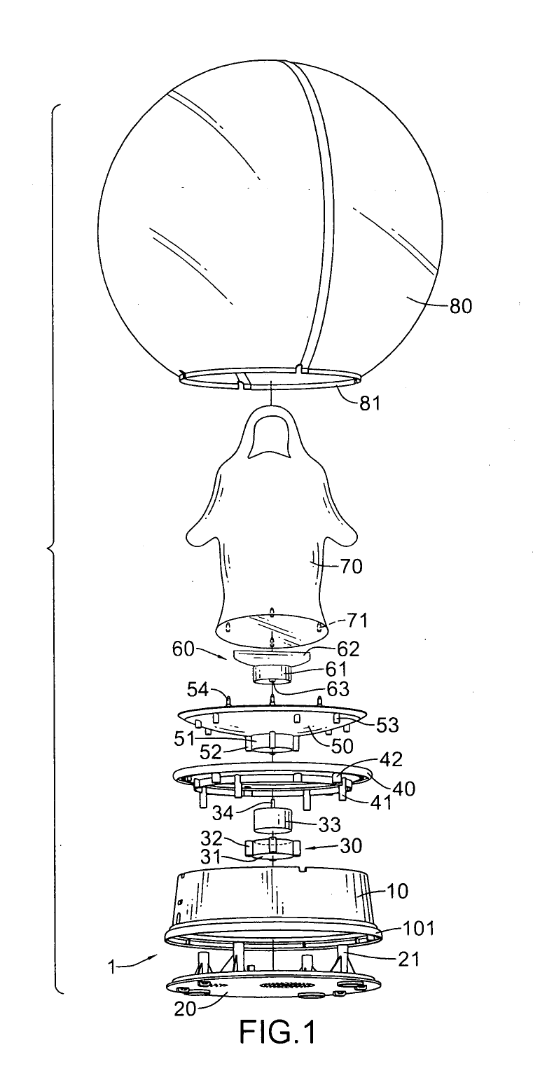

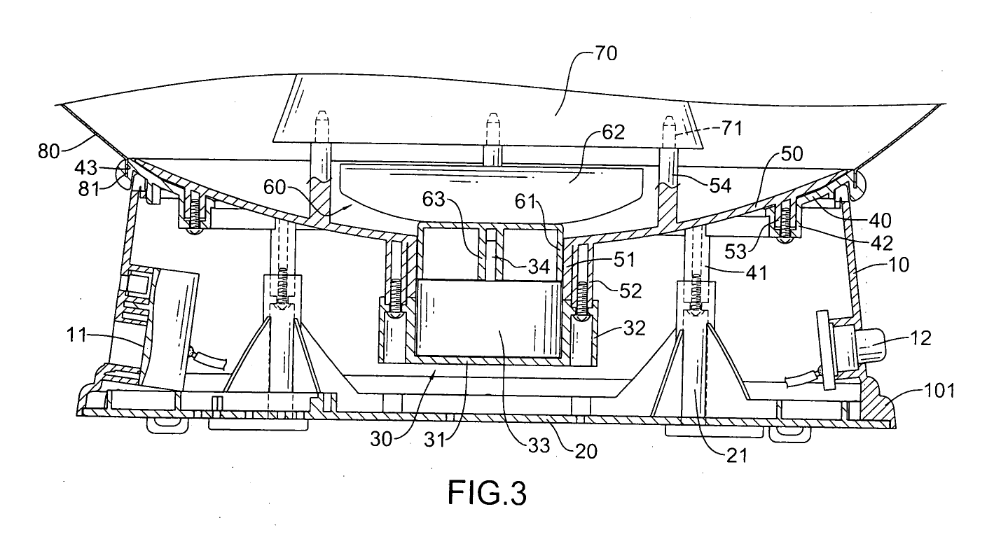

With reference to FIGS. 1-3, a decorative cyclone globe comprises a driving assembly (1), a spherical shell (80), a central decoration (70) and multiple flying objects (90).

The driving assembly (1) has a pedestal, a motor (33) and a blower (60).

The pedestal has a base (20), a base bracket (10), a mounting ring (40), a mounting dish (50), an optional power socket (11) and an optional power switch (12).

The base (20) has an outer edge, a top surface and multiple optional connecting tubes (21). The connecting tubes (21) are formed on and protrude from the top surface of the base (20).

The base bracket (10) is mounted on the base (20) and has a tubular wall and an optional annular connecting lip (101). The tubular wall of the base bracket (10) has a bottom edge and a top edge. The annular connecting lip (101) is formed on and protrudes from the bottom edge of the tubular wall of the base bracket (10) and corresponds to and is mounted on the outer edge of the base (20).

The mounting ring (40) is mounted on the top edge of the tubular wall of the base bracket (10) and has a bottom, a top, an outer edge, multiple optional mounting ring fasteners, multiple optional inner connecting tubes (41), multiple optional outer connecting tubes (42) and an optional annular slot (43). The mounting ring fasteners may be bolts, screws, rods or the like. The inner connecting tubes (41) are formed on and protrude from the bottom of the mounting ring (40), correspond to and are mounted respectively in the connecting tubes (21) on the base (20) and are connected securely to the connecting tubes (21) on the base (20) by the mounting ring fasteners. The outer connecting tubes (42) are formed on and protrude from the bottom of the mounting ring (40), and each outer connecting tube (42) has a through hole and an optional closed bottom end. The through hole is defined though the mounting ring (40). The closed bottom end may have a bolt hole. The annular slot (43) is defined in the top of the mounting ring (40) near the outer edge of the mounting ring (40).

The mounting dish (50) is concave, is mounted on the mounting ring (40) and has a bottom surface, a top surface, a motor bracket (51), multiple optional mounting dish fasteners, a motor bracket cap (30), multiple optional lower connecting tubes (53) and multiple optional connecting rods (54).

The motor bracket (51) is formed on and protrudes from the bottom surface of the mounting dish (50), extends down through the mounting ring (40) and has a cylindrical surface, a through hole, multiple optional motor bracket fasteners and multiple optional connecting tubes (52). The through hole in the motor bracket (51) is defined through the motor bracket (51) and the mounting dish (50). The motor bracket fasteners may be bolts, screws, rods or the like. The connecting tubes (52) are formed longitudinally on and around the cylindrical surface of the motor bracket (51).

The mounting dish fasteners may be bolts, screws, rods or the like.

The motor bracket cap (30) is mounted on the motor bracket (51) under the mounting dish (50) and has a bottom (31), a cylindrical surface and multiple optional connecting tubes (32). The connecting tubes (32) are formed longitudinally on and around the cylindrical surface of the motor bracket cap (30), correspond to and are mounted respectively on the connecting tubes (52) on the motor bracket (51) and may be held securely in place with the motor bracket fasteners.

The lower connecting tubes (53) are formed on and protrude from the bottom of the mounting dish (50) around the motor bracket (51), correspond to and are mounted respectively in the outer connecting tubes (42) on the mounting ring (40) to connect the mounting dish (50) to the mounting ring (40) and may be held securely in place with mounting dish fasteners.

The connecting rods (54) are formed on and protrude from the top of the mounting dish (50) around the motor bracket (51).

The power socket (11) is mounted through the tubular wall of the base bracket (10) and is connected electrically to an external power supply.

The power switch (12) is mounted through the tubular wall of the base bracket (10) and is connected electrically to the power socket (11).

The motor (33) is mounted in the motor bracket cap (30) against the bottom of the motor bracket cap (30), is connected to the power switch (12) that turns electricity to the motor (33) on and off when the power socket (11) is connected to an external power source and has a shaft (34). The shaft (34) is rotated by and protrudes up from the motor (33).

The blower (60) is mounted on the shaft (34) of the motor (33), rotates with the shaft (34) of the motor (33) and has an extension tube (63), multiple blades (62) and an optional base (61). The extension tube (63) is mounted on and rotates with the shaft (34) of the motor (33) and has an open lower end and a closed upper end. The open lower end is mounted around the shaft (34) of the motor (33). The closed upper end extends into the mounting dish (50). The blades (62) are formed on and protrude radially out from the closed upper end of the extension tube (63) and generate a swirling wind when the blower (60) rotates, and each blade (62) has a bottom edge. The base (61) is an inverted cup shape, is formed on the extension tube (63), is mounted rotatably in the motor bracket (51) and has a top and a cylindrical sidewall. The top of the base (61) is formed on and extends radially out from the closed upper end of the extension tube (63), is connected to the bottom edges of the blades (62) and has an outer edge. The cylindrical sidewall is formed on and protrudes down from the outer edge of the top of the base (61) and extends into the motor bracket (51).

The spherical shell (80) is transparent, is mounted on the mounting ring (40) of the driving assembly (1), has an open bottom and an optional annular skirt (81) and may be two semispherical shells. The open bottom of the spherical shell is mounted on the mounting ring (40) around the mounting dish (50). The annular skirt (81) is formed on and protrudes from the open bottom of the spherical shell (80) and is mounted in the annular slot (43) in the mounting ring (40) to form a visible closed environment inside the spherical shell (80). The semispherical shells are transparent, are connected to each other to form the spherical shell (80), and each semispherical shell has a curved bottom edge and an optional annular skirt. The annular skirt is formed on and protrudes down from the curved bottom edge of the semispherical shell.

The central decoration (70) is mounted on the mounting dish (50) inside the spherical shell (80), has a bottom and multiple optional mounting holes (71) and may be a single character or a model of a village, a hill, etc. to depict a theme. The mounting holes (71) are defined in the bottom of the central decoration (70) and are mounted respectively on the connecting rods (54) of the mounting dish (50).

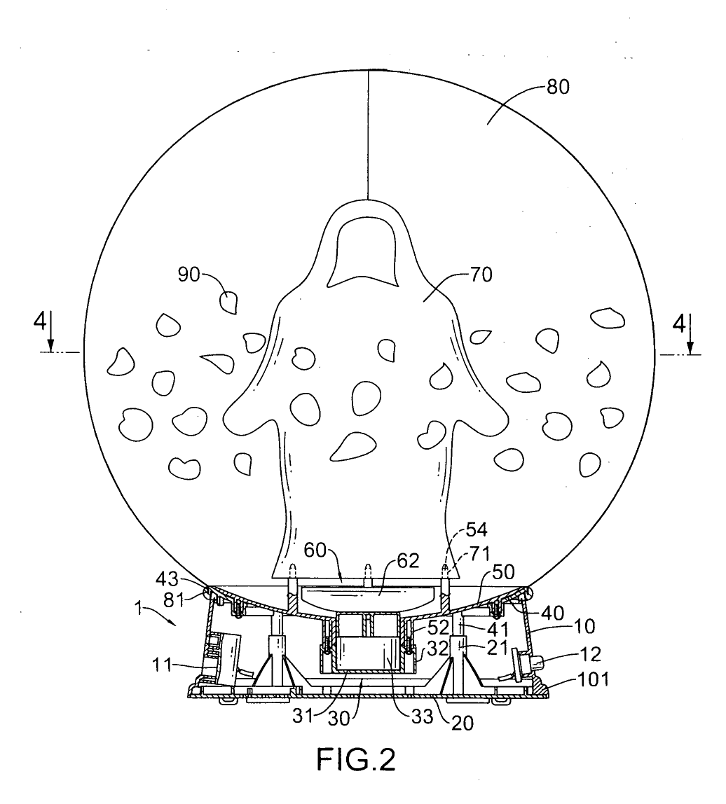

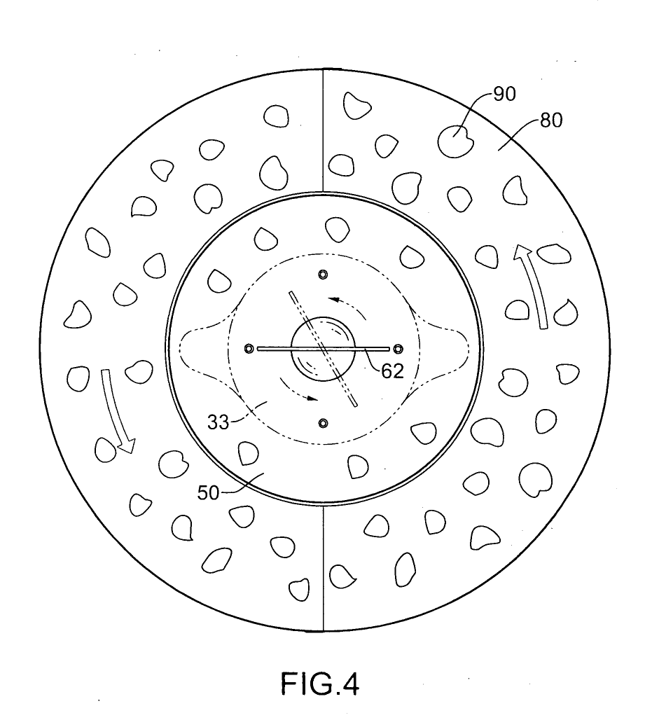

With further reference to FIGS. 2 and 4, the flying objects (90) are loose in the spherical shell (80), lie on the mounting dish (50) in a default situation and fly with the swirling wind generated by the blower (60) inside the spherical shell (80) to present a dynamic effect, e.g. a blizzard, a hurricane, a tornado or the like.

A visible closed environment is formed in the spherical shell (80) so that the decorative cyclone globe with the central decoration (70) mounted inside the spherical shell (80) and the flying objects (90) flying in the spherical shell (80) is capable of depicting a dynamic theme.

Even though numerous characteristics and advantages of the present invention have been set forth in the foregoing description, together with details of the structure and features of the invention, the disclosure is illustrative only. Changes may be made in the details, especially in matters of shape, size and arrangement of parts within the principles of the invention to the full extent indicated by the broad general meaning of the terms in which the appended claims are expressed.

What is claimed is:

1. A decorative cyclone globe comprising
a driving assembly having
a pedestal having;
a base having an outer edge and a top surface;
a base bracket being mounted on the base and having a tubular wall having
a bottom edge; and
a top edge;
a mounting ring being mounted on the top edge of the tubular wall of the base bracket and having
a bottom;
a top; and
an outer edge; and
a mounting dish being concave, being mounted on the mounting ring and having
a bottom surface;
a top surface;
a motor bracket being formed on and protruding from the bottom surface of the mounting dish, extending down through the mounting ring and having
a cylindrical surface; and
a through hole being defined through the motor bracket and the mounting dish; and
a motor bracket cap being mounted on the motor bracket under the mounting dish and having a bottom and a cylindrical surface;
a motor being mounted in the motor bracket cap against the bottom of the motor bracket cap and having a shaft being rotated by and protruding up from the motor; and
a blower being mounted on the shaft of the motor, rotating with the shaft and having
an extension tube being mounted on and rotating with the shaft of the motor and having
an open lower end being mounted around the shaft of the motor; and
a closed upper end extending into the mounting dish; and
multiple blades being formed on and protruding radially out from the closed upper end of the extension tube to generate a swirling wind when the blower rotates, and each blade having a bottom edge;
a spherical shell being transparent, being mounted on the mounting ring of the driving assembly and having an open bottom mounted on the mounting ring around the mounting dish;
a central decoration being mounted on the mounting dish inside the spherical shell and having a bottom; and
multiple flying objects being loose in the spherical shell, lying on the mounting dish in a default situation and flying with the swirling wind generated by the blower inside the spherical shell.

2. The decorative cyclone globe as claimed in claim 1, wherein the base bracket further has an annular connecting lip formed on and protruding from the bottom edge of the tubular wall of the base bracket, corresponding to and mounted on the outer edge of the base.

3. The decorative cyclone globe as claimed in claim 2, wherein
the base further has multiple connecting tubes formed on and protruding from the top surface of the base; and
the mounting ring further has multiple inner connecting tubes formed on and protruding from the bottom of the mounting ring, corresponding to and mounted respectively in the connecting tubes of the base.

4. The decorative cyclone globe as claimed in claim 3, wherein
the mounting ring further has multiple outer connecting tubes formed on and protruding from the bottom of the mounting ring, and each outer connecting tube has a through hole defined though the mounting ring; and
the mounting dish further has multiple lower connecting tubes formed on and protruding from the bottom of the mounting dish around the motor bracket, corresponding to and mounted respectively in the outer connecting tubes of the mounting ring to connect the mounting dish to the mounting ring.

5. The decorative cyclone globe as claimed in claim 4, wherein
the motor bracket further has multiple connecting tubes formed longitudinally on and around the cylindrical surface of the motor bracket; and
the motor bracket cap further has multiple connecting tubes formed longitudinally on and around the cylindrical surface of the motor bracket cap, corresponding to and mounted respectively on the connecting tubes of the motor bracket.

6. The decorative cyclone globe as claimed in claim 1, wherein
the blower further has a base being an inverted cup shape, mounted rotatably in the motor bracket and having
a top formed on and extending radially out from the closed upper end of the extension tube of the blower, connected to the bottom edges of the blades and having an outer edge; and
a cylindrical sidewall formed on and protruding down from the outer edge of the top of the base of the blower and extending into the motor bracket.

7. The decorative cyclone globe as claimed in claim 2, wherein
the blower further has a base being an inverted cup shape, mounted rotatably in the motor bracket and having
a top formed on and extending radially out from the closed upper end of the extension tube of the blower, connected to the bottom edges of the blades and having an outer edge; and
a cylindrical sidewall formed on and protruding down from the outer edge of the top of the base of the blower and extending into the motor bracket.

8. The decorative cyclone globe as claimed in claim 3, wherein
the blower further has a base being an inverted cup shape, mounted rotatably in the motor bracket and having
a top formed on and extending radially out from the closed upper end of the extension tube of the blower, connected to the bottom edges of the blades and having an outer edge; and
a cylindrical sidewall formed on and protruding down from the outer edge of the top of the base of the blower and extending into the motor bracket.

9. The decorative cyclone globe as claimed in claim 4, wherein
the blower further has a base being an inverted cup shape, mounted rotatably in the motor bracket and having
a top formed on and extending radially out from the closed upper end of the extension tube of the blower, connected to the bottom edges of the blades and having an outer edge; and
a cylindrical sidewall formed on and protruding down from the outer edge of the top of the base of the blower and extending into the motor bracket.

10. The decorative cyclone globe as claimed in claim 5, wherein
the blower further has a base being an inverted cup shape, mounted rotatably in the motor bracket and having
a top formed on and extending radially out from the closed upper end of the extension tube of the blower, connected to the bottom edges of the blades and having an outer edge; and
a cylindrical sidewall formed on and protruding down from the outer edge of the top of the base of the blower and extending into the motor bracket.

11. The decorative cyclone globe as claimed in claim 6, wherein
the mounting dish further has multiple connecting rods formed on and protruding from the top of the mounting dish around the motor bracket; and
the central decoration further has multiple mounting holes defined in the bottom of the central decoration and mounted respectively on the connecting rods of the mounting dish.

12. The decorative cyclone globe as claimed in claim 7, wherein
the mounting dish further has multiple connecting rods formed on and protruding from the top of the mounting dish around the motor bracket; and
the central decoration further has multiple mounting holes defined in the bottom of the central decoration and mounted respectively on the connecting rods of the mounting dish.

13. The decorative cyclone globe as claimed in claim 8, wherein
the mounting dish further has multiple connecting rods formed on and protruding from the top of the mounting dish around the motor bracket; and
the central decoration further has multiple mounting holes defined in the bottom of the central decoration and mounted respectively on the connecting rods of the mounting dish.

14. The decorative cyclone globe as claimed in claim 9, wherein
the mounting dish further has multiple connecting rods formed on and protruding from the top of the mounting dish around the motor bracket; and
the central decoration further has multiple mounting holes defined in the bottom of the central decoration and mounted respectively on the connecting rods of the mounting dish.

15. The decorative cyclone globe as claimed in claim 10, wherein
the mounting dish further has multiple connecting rods formed on and protruding from the top of the mounting dish around the motor bracket; and
the central decoration further has multiple mounting holes defined in the bottom of the central decoration and mounted respectively on the connecting rods of the mounting dish.

16. The decorative cyclone globe as claimed in claim 1, wherein
the mounting ring further has an annular slot defined in the top of the mounting ring near the outer edge; and
the spherical shell further has an annular skirt formed on and protruding from the open bottom of the spherical shell and mounted in the annular slot in the mounting ring.

17. The decorative cyclone globe as claimed in claim 1, wherein
the pedestal further has
a power socket mounted through the tubular wall of the base bracket; and
a power switch mounted through the tubular wall of the base bracket and connected electrically to the power socket; and
the motor is connected electrically to the power switch.
